(19) United States
(12) Patent Application Publication
(10) Pub. No.: US 2004/0013790 A1
(43) Pub. Date: Jan. 22, 2004

(54) Oil seed processing

(76) Inventor: Gavyn Anderson, Victoria (AU)

Correspondence Address: Morris Liss, Connolly Bove Lodge & Hutz, PO Box 19088, Washington, DC, 20036-3425, US

(21) Appl. No.: 10/344,583

(22) PCT Filed: Aug. 10, 2001
(86) PCT No.: PCT/AU01/00983

(30) Foreign Application Priority Data
Aug. 11, 2000 (AU) PQ9310
Mar. 2, 2001 (AU) PR3440

(51) Int. Cl. A23L 1/36

(52) U.S. Cl. 426/629

(57) ABSTRACT

Sesame seeds are dehulled, coarsely ground while still wet in the presence of a 70/30 water alcohol mixture, to extract the oil. The oil is removed by decanting and the coarsely ground seeds are separated from the remaining liquids and dried. A further fine grinding produces a good quality sesame seed flour. The flour may be further treated to extract water soluble proteins and these may be treated with enzymes to produce peptides.

### BACKGROUND TO THE INVENTION

Most oil seeds are processed to extract oil and the ground seed by product is usually sold as meal for animal feed.

The seeds may be cold crushed to extract the oil but the residual oil left in the crushed seeds is still above 10% usually about 13%.

The expeller process heats the seeds and then crushes them in a screw press to extract the oil. The expeller process is more efficient than the cold press technique but still leaves about 9% oil in the meal residue.

Solvent extraction has been used to extract oil from this residue to reduce the oil content of the meal to 1%. The solvent that is most effective is hexane. This has the disadvantage of requiring extensive clean up to reduce the residual hexane in the meal by product if it is intended for human use. The meal by product is only fit for animal feeds and can not be used for human foods unless hexane is removed by washing, usually in a water alcohol solution.

U.S. Pat. No. 5,928,696 discloses a method in which the solvent is water and alcohol.

This process is not as efficient or cost effective as the hexane process but it leaves little unwanted solvent in the dry residue and the residue is fit for human consumption. However the method is time and energy consuming for some seeds such as sesame seeds because they have to be dehulled in the wet state, dried, ground mixed with alcohol and then the oil is extracted using specially designed decanters. There also remains the problem that to make the process as cost effective as possible the by products have to be valuable commodities as well. Japanese patent 9187226 discloses an extraction method using hexane to remove oil and then treating the defatted material with an enzyme to give a protein peptide mixture.

Japanese patent 10014526 discloses the treatment of defatted sesame seed with an acid resistant protease to form peptides and amino acids having a large amount of bonds to trace metals.

It is an object of this invention to provide a safe an efficient method of producing a low fat flour and protein extracts from oil seeds.

### BRIEF DESCRIPTION OF THE INVENTION

To this end the present invention provides a method of producing a flour from oil seeds which includes the steps of

a) dehulling the seeds in the wet state and removing the hulls

b) coarse grinding the wet dehulled seeds

c) agitating the wet dehulled seeds either during or after grinding in the presence of a water and alcohol mixture to release oil from the seeds

d) decanting the oil from the ground seeds

e) optionally repeating step d)

f) drying the ground seeds and

g) finely grinding the ground seeds to form a flour at any time after step d).

This invention is predicated on the discovery that extraction of oil from finely ground wet seeds is inhibited by the fine particle sizes of the fibres. The necessity of using dry seeds for the initial grinding adds extra cost where dehulling has to be carried out with wet seeds.

In order to dehull the seeds the cleaned seeds are saturated with 50-100% by weight of water.

After dehulling, the wet seeds are coarsely ground to a particle size below 700 microns preferably 300-500 microns.

The alcohol added to the water in the oil extraction process is preferably ethanol but any lower aliphatic alcohol such as methanol, propanol, or butanol may be used. The alcohol content is from 10 to 40% by weight of total added water including the added water absorbed into the dehulled seeds. A preferred water/alcohol mix is 70/30. The alcohol may be added to the dehulled seeds prior to the addition of more water. The solids content of the alcohol/water slurry is 30-60% by weight.

After the agitation with the water/alcohol mix the slurry is allowed to settle and is then decanted by taking advantage of the fact that the oil phase will separate and float above the water/fibre phase. Using less than 40% alcohol ensures that an emulsion of the oil in the aqueous phase is avoided making separation of the oil a simpler task.

After the first decanting another quantity of water and alcohol is added with agitation and a second decanting is carried out to extract additional oil.

During the grinding, solvent extraction and drying the temperature is preferably maintained below 70° C. to prevent degradation of the flour or oil.

The separated oil is filtered and cleaned to complete the refining.

The coarse ground fibres are reground to a particle size below 250 microns and are then dried to a moisture content below 5%. The resultant flour has an oil content below 5%.

This process is applicable to all oil seeds and in particular sesame seeds.

Quality sesame seed flour can bring a better price than the oil so that this process makes it possible to process sesame seeds in a safe, natural process that produces two high quality products. Oil seed flour with protein contents greater than wheat flour are attractive because some of the protein content can be extracted without affecting the marketability of the flour.

In another aspect of this invention there is provided a method of extracting protein from oil seeds which comprises the steps of

a) dehulling the seeds in a wet state and removing the hulls

b) coarse grinding the wet dehulled seeds

c) agitating the wet dehulled seeds either during or after grinding in the presence of a water and alcohol mixture to release oil from the seeds

d) decanting the oil from the ground seeds

e) optionally repeating steps c) and d)

f) adding warm water to the oil extracted ground seeds and decanting the water phase which contains carbohydrate fibre which can be separated and dried.

g) optionally repeating step f)

h) adjusting the pH of the warm water phase to be within the range of 3 to 7 preferably 3 to 5

i) clarifying the water phase into water and protein paste

j) optionally washing the protein paste with warm water and repeating step i)

k) optionally treating the protein paste with an enzyme to produce a peptide mixture

1) and optionally separating the peptide fraction from the protein.

The water soluble proteins extracted in this way can be sold as a food ingredient or as a protein supplement.

Sesame peptides are physiologically active and some have been identified as useful in treating hypertension.

Also present in sesame seeds are anti-oxidant compounds, lignans. Some of these are oil soluble [about two thirds] and will be present in the extracted oils and the remainder which are water soluble will be associated with the extracted proteins.

Sesame lignans are sought after as natural bioactive compounds for use as pharmaceuticals and nutriceuticals.

The oil extracted seeds may be fine ground prior to the protein extraction.

Alternately the oil and protein extracted seeds can be fine ground to form a flour.

The fibre extracted during the protein extraction can be used as a food ingredient or blended with other flour.

The dried protein extracted flour is usually of improved colour with the extraction of the protein and is quite marketable particularly for blending. The degree of protein extraction can be selected by the number of repetitions of the extraction steps h) and 1) and this also adjusts the protein content of the resulting flour.

### DETAILED DESCRIPTION OF THE INVENTION

The processing of sesame seeds to produce oil and flour in accordance with the present invention will be described.

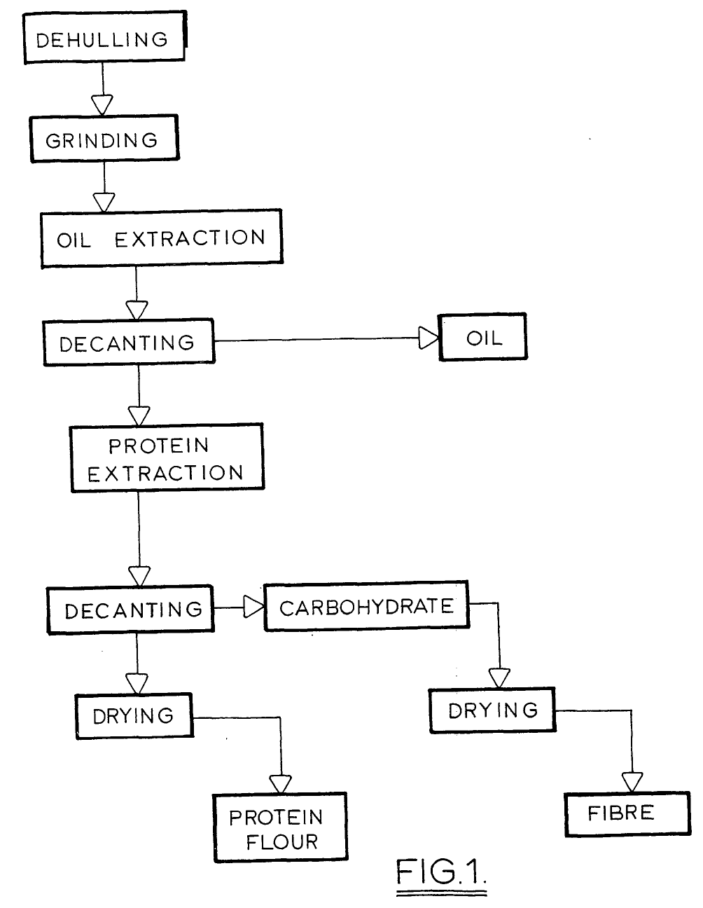

FIG. 1 is a schematic flow diagram of the main steps in the process. The steps as shown may be repeated to increase yields.

### DEHULLING

To 1 kg of sesame seeds is added 1 litre of water and allowed to soak for 4 minutes. The soaked seeds were then placed in a rotating sieve for about 5 minutes and agitated to remove the hulls from the seed.

### Oil Extraction

250 ml of ethanol was added to the dehulled seeds and placed in a grinding mill. During grinding a 500 ml of water was added. The grinding raised the temperature of the mixture to 60° C. After grinding for thirty minutes the slurry was placed in an inclined decanter which gently agitated the slurry and allowed the oil phase to be removed. 300 grams of oil were collected

The deoiled slurry was returned to the grinder for further agitation. If necessary additional alcohol may be added at this stage.

After another thirty minutes agitation the slurry was returned to the decanter for a second stage separation where 90 grams of oil were recovered.

The oil was filtered and clarified and was then ready for bottling.

If necessary the oil may be bleached to improve the colour.

The specification of the oil produced was:

| | | | |
|---|---|---|---|
| Color-lovibond | yellow50/red 3.9 | Peroxide value [meq/kg] | 0.68 |
| Flavour | slight nutty | Free fatty acid % oleic | 0.93 |
| Appearance | Clear | Phosphorous | 0.003 |
| Saponification value | 190-195 | Smokepoint | 190-200° C. |
| Relative density | 0.910-0.925 | Impurities | Max. 0.3% |
| Foots | Clear at 65° C. | | |

The main fatty acid components of the oil are:

| | |
|---|---|
| Palmitic | 9% |
| Stearic | 5% |
| Oleic | 45% |
| Linoleic | 41% |
| Lonoleic | 0% |
| Total saturated | 14% |
| Total monounsaturated | 45% |
| Total polyunsaturated | 41% |

### Liquid Recovery

The residue from the oil recovery was separated into a liquid and solid phase.

The liquid phase was placed in an evaporator to recover the alcohol for reuse in the oil extraction step. The water was also recycled for reuse. If there are water soluble allergans present in the extracted water phase these are preferably removed and evaporation of the water is one option.

### Flour Preparation

The solids from the liquid separation were placed in a drier below 70° C. for a time sufficient to reduce the moisture content of the coarse flour to below 5%.

After drying the coarse flour was fine ground to below 250 microns. The resultant product was a fine white flour with an oil content below 5%.

To produce a high protein flour the solids are treated with water at a temperature below 60° C. to extract soluble protein. The pH of the solution is generally adjusted to within the range of 3 to 7 to precipitate the protein. This extraction is usually performed twice. The protein paste is dried and used as a high protein flour or as a protein powder additive or formed into tablets for use as a protein supplement.

The flour specification is:

| Mesh size | <300 microns |
|---|---|
| Moisture | 4% |
| Protein | 65-75% |
| Oil | 5% |
| Ash | 7.3% |
| Soluble sugars | 7.5% |
| Fibre | 3.5% |
| Starch | 7.1% |
| Minerals | 6.5% |
| Impurity | 0.0% |

The mineral content is made up of calcium, iron, selenium, manganese, zinc, copper, cobalt, phosphorous.

The functional properties of the flour are:

| | |
|---|---|
| Fat absorption (%) g oil/g flour | 185 |
| Water absorption (%) g water/g flour | 198 |
| Emulsification activity | 45.2 |
| Emulsification stability | 85.2 |

The amino acid analysis of the high protein flour in g/100 g protein is:

| | |
|---|---|
| Arginine | 12.9 |
| Histidine | 2.6 |
| Isoleucine | 3.6 |
| Leucine | 6.8 |
| Lysine | 1.3 |
| Methionine | 3.2 |
| Phenylalanine | 4.4 |
| Threonine | 3.6 |
| Triptophan | 1.9 |
| Valine | 4.3 |
| Cysteine | 1.2 |
| Aspartic | 7.8 |
| Glutamic acid | 14.2 |
| Serine | 4.0 |
| Glycine | 4.3 |
| Proline | 6.8 |

### Peptides and Lignans

The protein solution can be treated with an enzyme, preferably a protease or an hydrolytic enzyme to produce a protein peptide mixture. This mix can be used as a food additive or supplement.

Additionally the peptide protein mix can be separated by any suitable technique to separate out the peptide fraction. Ultrafiltration through a suitable membrane is preferred.

Lignans can be separated from the oil phase or the protein by Ultra filtration.

From the above description it can be seen that this invention provides a cost effective method of producing flour and oil from sesame seeds.

1) A method of producing a flour and oil from oil seeds which includes the steps of
a) dehulling the seeds in the wet state and removing the hulls
b) coarse grinding the wet dehulled seeds
c) agitating the wet dehulled seeds either during or after grinding in the presence of a water and alcohol mixture to release oil from the seeds
d) decanting the oil from the ground seeds
e) optionally repeating step d)
f) drying the ground seeds and
g) finely grinding the ground seeds to form a flour at any time after step d).

2) A method as claimed in claim 1 in which sesame seeds are used.

3) A method as claimed in claim 2 wherein alcohol in an amount of 30% by weight of the dry seeds is added to the dehulled seeds prior to grinding.

4) A method of extracting a high protein flour and oil from oil seeds which comprises the steps of
a) dehulling the seeds in a wet state and removing the hulls
b) coarse grinding the wet dehulled seeds
c) agitating the wet dehulled seeds either during or after grinding in the presence of a water and alcohol mixture to release oil from the seeds
d) decanting the oil from the ground seeds
e) optionally repeating steps c) and d)
f) adding warm water to the oil extracted ground seeds and decanting the water phase
g) optionally repeating step f)
h) adjusting the pH of the warm water phase to be within the range of 3 to 7 preferably 3 to 5
i) clarifying the water phase into water and protein paste
j) optionally washing the protein paste with warm water and repeating step i)
k) drying the protein rich paste to form a high protein flour

5) A method of producing sesame peptides which consists of treating the protein paste obtained in the process of claim 4 with an enzyme to produce a peptide mixture and optionally separating the peptide fraction from the protein.

6) A flour produced by the method of claim 1 wherein the oil seed is sesame.

7) A high protein flour produced by the method of claim 4 wherein the oil seed is sesame.

8) A sesame oil produced by the method defined in claim 1 or 4.
